(19) United States
(12) Patent Application Publication
(10) Pub. No.: US 2013/0132988 A1
(43) Pub. Date: May 23, 2013

(54) SYSTEM AND METHOD FOR CONTENT RECOMMENDATION

(71) Applicant: Electronics and Telecommunications Research Int, Daejeon (KR)

(72) Inventors: Seung Jae LEE, Daejeon (KR); Jung Hyun KIM, Daejeon (KR); Sung Min KIM, Daejeon (KR); Yong Seok SEO, Daejeon (KR); Jee Hyun PARK, Daejeon (KR); Sang Kwang LEE, Daejeon (KR); Jung Ho LEE, Wonju (KR); Young Suk YOON, Daejeon (KR); Young Ho SUH, Daejeon (KR); Won Young YOO, Daejeon (KR)

(73) Assignee: ELECTRONICS AND TELECOMMUNICATIONS RESEARCH INSTITUTE, Daejeon (KR)

(21) Appl. No.: 13/652,366

(22) Filed: Oct. 15, 2012

(30) Foreign Application Priority Data
Nov. 21, 2011 (KR) 10-2011-0121337

(51) Int. Cl. H04N 21/24

(52) U.S. Cl. 725/14

(57) ABSTRACT

Disclosed are a system and method for recommending contents. The content recommendation method includes: receiving audio data or a fingerprint and emotion information of the audio data; extracting a fingerprint and emotion information of the received audio data when the audio data is received; extracting video information corresponding to the fingerprint and emotion information of the audio data to provide the extracted video information to a user if video recommendation is requested; and extracting audio information corresponding to the fingerprint and emotion information of the audio data to provide the extracted audio information to the user if audio recommendation is requested.

### CLAIM FOR PRIORITY

This application claims priority to Korean Patent Application No. 10-2011-0121337 filed on Nov. 21, 2011 in the Korean Intellectual Property Office (KIPO), the entire contents of which are hereby incorporated by reference.

### BACKGROUND

1. Technical Field

Example embodiments of the present invention relate in general to a system and method for content recommendation, and more specifically, to a system and method for content recommendation such as music, broadcasting, etc.

2. Related Art

With the development of the Internet and multimedia technologies, users can receive desired contents through the Internet anywhere at any time. However, due to the rapid increase in the amount of contents, more time and effort are required to find desired contents and, even in this case, unnecessary contents as well as the desired contents may be found. In particular, the number of music contents is very great. Thus, technology for quickly and accurately finding or recommending desired music contents is needed.

In prior art, users use metadata describing music content, which is information regarding its genre and artist, in order to find the desired music contents or receive recommendation of the desired music contents. A method using the information regarding the genre and artist includes searching a music database (DB), which stores music files of genres similar to the desired music file, to recommend the music file to the user, or searching a music database (DB), which stores music files of artists similar to the desired music, to recommend the music file to the user.

This method has a problem in that the music file is recommended to the user using only metadata on the music file and thus music files recommendable to the user can not be but limited, and the needs of the user can not be satisfied. Also, this method has another problem in that only information about a music file desired by a user can be provided, and a variety of information such as music video, music broadcasting, etc. can not be provided, and thus the various needs of the user can not be satisfied.

### SUMMARY

Accordingly, example embodiments of the present invention are provided to substantially obviate one or more problems due to limitations and disadvantages of the related art.

Example embodiments of the present invention provide a system for recommending contents in consideration of characteristics of data on desired music and emotion felt from the music in order to provide a variety of content information associated with the music.

Example embodiments of the present invention also provide a method of recommending contents in consideration of characteristics of data on desired music and emotion felt from the music in order to provide a variety of content information associated with the music.

In some example embodiments, a content recommendation system includes: a first extraction unit extracting a fingerprint and emotion information of audio data; a second extraction unit extracting a fingerprint and emotion information of audio data for video; a generation unit adding video metadata to the fingerprint extracted by the second extraction unit to provide the added fingerprint to a fingerprint DB, and adding the video metadata to the emotion information extracted by the second extraction unit to provide the added fingerprint to an emotion DB; a search unit finding a video fingerprint or audio fingerprint corresponding to the fingerprint extracted by the first extraction unit in the fingerprint DB, and finding video emotion information or audio emotion information corresponding to the emotion information extracted by the first extraction unit in the emotion DB; and a provision unit extracting at least one of video information corresponding to the video fingerprint and video emotion information found by the search unit and audio information and audio information corresponding to the audio fingerprint and audio emotion information found by the search unit.

The content recommendation system may further include: a storage unit storing real-time broadcasting data, in which the second extraction unit may extract a fingerprint and emotion information of audio data for the broadcasting data stored in the storage unit, and the generation unit may add broadcasting metadata to the fingerprint extracted by the second extraction unit to generate a video fingerprint, and may add the broadcasting metadata to the emotion information extracted by the second extraction unit to generate video emotion information.

The emotion information may be an arousal-valence (AV) coefficient of each data.

The first extraction unit and the second extraction unit may extract the fingerprint of the audio data with one of zero crossing rate (ZCR), energy difference, spectral flatness, mel-frequency cepstral coefficients (MFCC), and frequency centroids algorithms.

In other example embodiments, a content recommendation method includes: receiving audio data or a fingerprint and emotion information of the audio data; extracting a fingerprint and emotion information of the received audio data when the audio data is received; extracting video information corresponding to the fingerprint and emotion information of the audio data to provide the extracted video information to a user if video recommendation is requested; and extracting audio information corresponding to the fingerprint and emotion information of the audio data to provide the extracted audio information to the user if audio recommendation is requested.

The emotion information may be an arousal-valence (AV) coefficient of the audio data.

The extracting of the received fingerprint and emotion information of the audio data may be performed using one of zero crossing rate (ZCR), energy difference, spectral flatness, mel-frequency cepstral coefficients (MFCC), and frequency centroids algorithms.

The extracting of video information corresponding to the fingerprint and emotion information of the audio data may further include: finding a video fingerprint corresponding to the fingerprint of the audio data; finding video emotion information corresponding to the emotion information of the audio data; and extracting video information corresponding to the found video fingerprint and video emotion information to provide the extracted video information.

The extracting of audio information corresponding to the fingerprint and emotion information of the audio data may further include: finding an audio fingerprint corresponding to the fingerprint of the audio data; finding audio emotion information corresponding to the emotion information of the audio data; and extracting audio information corresponding to the found audio fingerprint and audio emotion information to provide the extracted audio information.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a configuration of a content recommendation system according to an embodiment of the present invention;

FIG. 2 is a flowchart illustrating a method of recommending content according to an embodiment of the present invention;

FIG. 3 is a flowchart illustrating a method of extracting video according to an embodiment of the present invention; and

FIG. 4 is a concept view showing an arousal-valence (AV) coordinate.

### DESCRIPTION OF EXAMPLE EMBODIMENTS

The invention may have diverse modified embodiments, and thus, example embodiments are illustrated in the drawings and are described in the detailed description of the invention.

However, this does not limit the invention within specific embodiments and it should be understood that the invention covers all the modifications, equivalents, and replacements within the idea and technical scope of the invention.

In the following description, the technical terms are used only for explaining a specific exemplary embodiment while not limiting the present invention. The terms of a singular form may include plural forms unless referred to the contrary. The meaning of ‘comprises’ and/or ‘comprising’ specifies a property, a region, a fixed number, a step, a process, an element and/or a component but does not exclude other properties, regions, fixed numbers, steps, processes, elements and/or components.

Unless terms used in the present disclosure are defined differently, the terms may be construed as meaning known to those skilled in the art. Terms such as terms that are generally used and have been in dictionaries should be construed as having meanings matched with contextual meanings in the art. In this description, unless defined clearly, terms are not ideally, excessively construed as formal meanings.

The term “fingerprint” described throughout this specification refers to characteristic data indicating a characteristic of a content, which may be referred to as fingerprint data, DNA data, or genetic data. For audio data, the fingerprint may be generated with frequency, amplitude, etc. which is characteristic data indicating characteristics of audio data. For video data, the fingerprint may be generated with motion vector information, color information, etc. of a frame which is characteristic data indicating characteristics of video data.

Throughout this specification, the term “emotion information” refers to activation and pleasantness levels of human emotion from any content, the term “audio” includes music, lecture, radio broadcasting, etc., the term “video” includes moving pictures, terrestrial broadcasting, cable broadcasting, music video, moving pictures provided by streaming service etc., the term “audio information” includes audio data, audio metadata (title, singer, genre, etc.), and the term “video information” includes video data, video metadata (title, singer, genre, broadcasting channel, broadcasting time, broadcasting title, etc.), music video information, an address of a website with moving pictures, an address of a website providing a streaming service, etc.

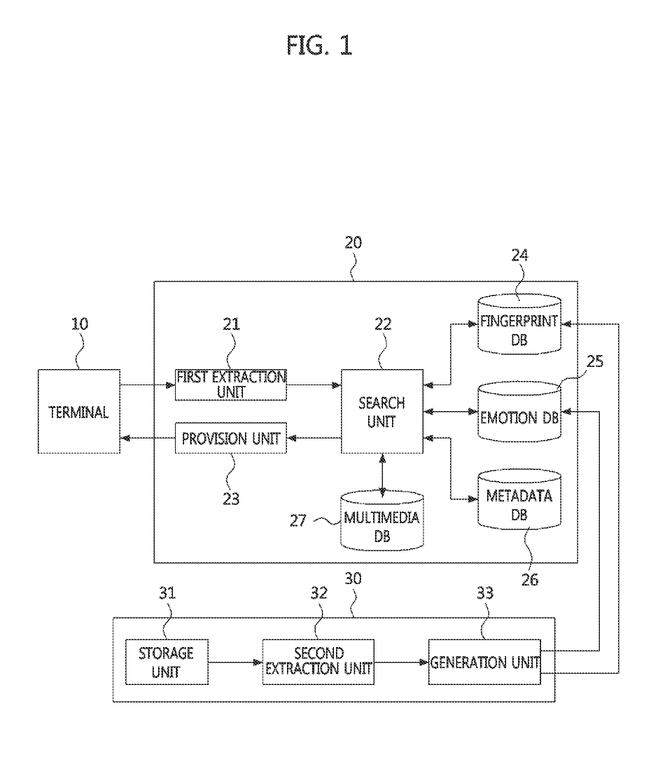

FIG. 1 is a block diagram showing a configuration of a content recommendation system according to an embodiment of the present invention.

Referring to FIG. 1, the content recommendation system may include only a content recommendation server 20, or may include a video extraction server 30 in addition to the content recommendation server 20. For convenience of description in embodiments of the present invention, the content recommendation server 20 and the video extraction server 30 are disclosed independently from each other. However, the content recommendation server 20 and the video extraction server 30 may be implemented in one form, one physical device, or one module. Furthermore, each of the content recommendation server 20 and the video extraction server 30 may be implemented in a plurality of physical devices or groups, not in a single physical device or group.

A terminal 10 transmits audio data or a fingerprint and emotion information of the audio data to the content recommendation server 20. When the terminal 10 transmits the audio data to the content recommendation server 20, the audio data may be all or a portion of the audio. Also, the terminal 10 may transmit audio data on a plurality of audios to the content recommendation server 20. The terminal 10 may receive at least one of audio information and video information from the content recommendation server 20.

Here, the terminal 10 is a device such as laptop, desktop, tablet PC, cell phone, smart phone, personal digital assistant, MP3 player, navigation, etc., which can communicate with the content recommendation server 20 by wire or wirelessly.

The content recommendation server 20 extracts at least one of the audio information and video information, which are associated with audio data received from a user, to provide the information to the user. The content recommendation server 20 may include a first extraction unit 210, a search unit 22, a provision unit 23, a fingerprint DB 24, and an emotion DB 25. The content recommendation server 20 may further include a metadata DB 26 and a multimedia DB 27.

For convenience of description in embodiments of the present invention, the extraction unit 21, the search unit 22, and the provision unit 23 are disclosed independently from each other. However, the extraction unit 21, the search unit 22, and the provision unit 23 may be implemented in one form, one physical device, or one module. Furthermore, each of the extraction unit 21, the search unit 22, and the provision unit 23 may be implemented in a plurality of physical devices or groups, not in a single physical device or group. Also, the fingerprint DB 24, the emotion DB 25, the metadata DB 26, and the multimedia DB 27 may be implemented in one DB.

The first extraction unit 21 extracts the fingerprint and emotion information from the audio data received from the user. The first extraction unit 21 may extract the fingerprint of the audio data using one of zero crossing rate (ZCR), energy difference, spectral flatness, mel-frequency cepstral coefficients, and frequency centroids algorithms.

The first extraction unit 21 may extract an arousal-valence (AV) coefficient of the audio data as emotion information. In this case, the first extraction unit 21 may extract characteristics of the audio data with a regression analysis using mel-frequency cepstral coefficients (MFCC), octave-based spectral contrast (OSC), energy, tempo, etc., and then apply the characteristics to an arousal-valence (AV) model to extract the AV coefficient. Here, the AV model intends to represent a level of human emotion from any content using an arousal level indicating an activation level of the emotion and a valence level indicating a pleasantness level of the emotion.

FIG. 4 is a concept view showing an arousal-valence coordinate. Referring to FIG. 4, the x-axis represents the valence indicating the pleasantness level of the emotion ranging from −1 to 1, and the y-axis represents the arousal indicating the activation level ranging from −1 to 1. A value of the AV coefficient may be represented with the AV coordinate.

Any of a variety of conventionally known methods can be employed as a method of extracting the emotion information of the audio data. Preferably, a method of generating an emotion model may be used which is disclosed in Korean patent application No. 10-2011-0053785 filed by the applicant.

The search unit 22 may extract at least one fingerprint from the fingerprint DB 24 according to similarity between the fingerprint of the audio data and the fingerprint stored in the fingerprint DB 24. That is, the fingerprint represents a frequency characteristic and an amplitude characteristic of the audio data. At least one fingerprint with a frequency characteristic and an amplitude characteristic similar to the fingerprint of the audio data may be extracted from the fingerprint DB 24.

The search unit 22 may extract at least one piece of the emotion information from the emotion DB 25 according to similarity between the emotion information of the audio data and the emotion information stored in the emotion DB 25. In this case, the AV coefficient may be used as emotion information. At least one AV coefficient which is similar to the AV coefficient of the audio data may be extracted from the emotion DB 25.

Here, the similarity may be set according to a user's request. That is, a relatively greater number of fingerprints or pieces of emotion information are extracted when the similarity is set to have a wide range, and a relatively less number of fingerprints or pieces of emotion information are extracted when the similarity is set to have a narrow range.

Here, the fingerprints of audio and video are stored in the fingerprint DB 24. Moreover, audio information and video information corresponding to the fingerprints may be stored in the fingerprint DB 24. Accordingly, when the search unit 22 extracts at least one fingerprint from the fingerprint DB 24, audio information and video information may be found corresponding to the extracted fingerprint.

Emotion information (AV coefficient) of audio and video is stored in the emotion DB 25. Moreover, audio information and video information corresponding to the emotion information may be further stored in the emotion DB 25. Accordingly, when the search unit 22 extracts at least one piece of the emotion information, audio information and video information may be found corresponding to the extracted pieces of emotion information.

Any of a variety of conventionally known methods can be employed as a method of extracting the fingerprints from the fingerprint DB 24. Preferably, a method of finding a fingerprint may be used which is disclosed in Korean patent application No. 10-2007-0037399 filed by the applicant.

Any of a variety of conventionally known methods can be employed as a method of extracting the emotion information from the emotion DB 25. Preferably, a method of finding music with an emotion model may be used which is disclosed in Korean patent application No. 10-2011-0053785 filed by the applicant.

Accordingly, the provision unit 23 extracts at least one of the video information and audio information corresponding to the fingerprint and emotion information found by the search unit 22 to provide the information to the user terminal 10. That is, the provision unit 23 extracts common video information from video information corresponding to the video fingerprint found by the search unit 22, and video information corresponding to video emotion information found by the search unit 22 to provide the extracted common video information to the user terminal 10. Here, video metadata included in the extracted common video information may be found in the metadata DB 26 to be provided to the user terminal 10, and video data may be found in the multimedia DB 27 to be provided to the user terminal 10.

Moreover, the provision unit 23 extracts common video information from video information corresponding to the video fingerprint found by the search unit 22, and video information corresponding to video emotion information found by the search unit 22 to provide the extracted common video information to the user terminal 10. Here, video metadata included in the extracted common audio information may be found in the metadata DB 26 to be provided to the user terminal 10, and audio data may be found in the multimedia DB 27 to be provided to the user terminal 10.

The provision unit 23 may provide only the audio information, only the video information, or both the audio information and the video information according to a user's request.

The video extraction server 30 may extract an audio fingerprint and emotion information of video to generate a video fingerprint and emotion information of real-time broadcasting as well as general moving pictures. The video extraction server 30 may include a storage unit 31, a second extraction unit 32, and a generation unit 33.

For convenience of description in embodiments of the present invention, the storage unit 31, the second extraction unit 32, and the generation unit 33 are disclosed independently from each other. However, the storage unit 31, the second extraction unit 32, and the generation unit 33 may be implemented in one form, one physical device, or one module. Furthermore, each of the storage unit 31, the second extraction unit 32, and the generation unit 33 may be implemented in a plurality of physical devices or groups, not in a single physical device or group.

The storage unit 31 stores real-time broadcasting data. In this case, all or a portion of broadcasting data about one broadcasting program may be stored.

The second extraction unit 32 may extract the fingerprint and emotion information with a portion of broadcasting data stored in the storage unit 31, and may extract the fingerprint and emotion information with only audio data of the broadcasting data.

The second extraction unit 32 may extract the fingerprint with one of zero crossing rate (ZCR), energy difference, spectral flatness, mel-frequency cepstral coefficients, and frequency centroids algorithms.

The second extraction unit 32 may extract an arousal-valence (AV) coefficient of the broadcasting data as emotion information. In this case, the second extraction unit 32 may extract characteristics of the broadcasting data with a regression analysis using mel frequency cepstral coefficients (MFCC), octave-based spectral contrast (OSC), energy, tempo, etc., and then apply the characteristics to an arousal-valence (AV) model to extract the AV coefficient.

The generation unit 33 may add video information to the audio fingerprint extracted by the second extraction unit 32 to generate video fingerprint, and then store the generated video fingerprint to the fingerprint DB 24. Moreover, the generation unit 33 may add video information to the audio emotion information extracted by the second extraction unit 32 to generate video emotion information, and then store the generated video emotion information to the emotion DB 25.

The fingerprint and emotion information of the real-time broadcasting data may be extracted through the video extraction server 30. The fingerprint DB 24 and the emotion DB 25 may be updated in real time by adding the video information to the extracted fingerprint and emotion information of the broadcasting data, and then storing the information to the fingerprint DB 24 and the emotion DB 25. A content broadcast in real time may be recommended to a user using the updated fingerprint DB 24 and the emotion DB 25. Here, the real-time broadcasting data may include terrestrial broadcasting, cable broadcasting, radio broadcasting, etc.

The configurations and functions of the content recommendation server, the video extraction server, and the content recommendation system according to an embodiment of the present invention have been described in detail above. Hereinafter, a content recommendation method according to an embodiment of the present invention will be described in detail.

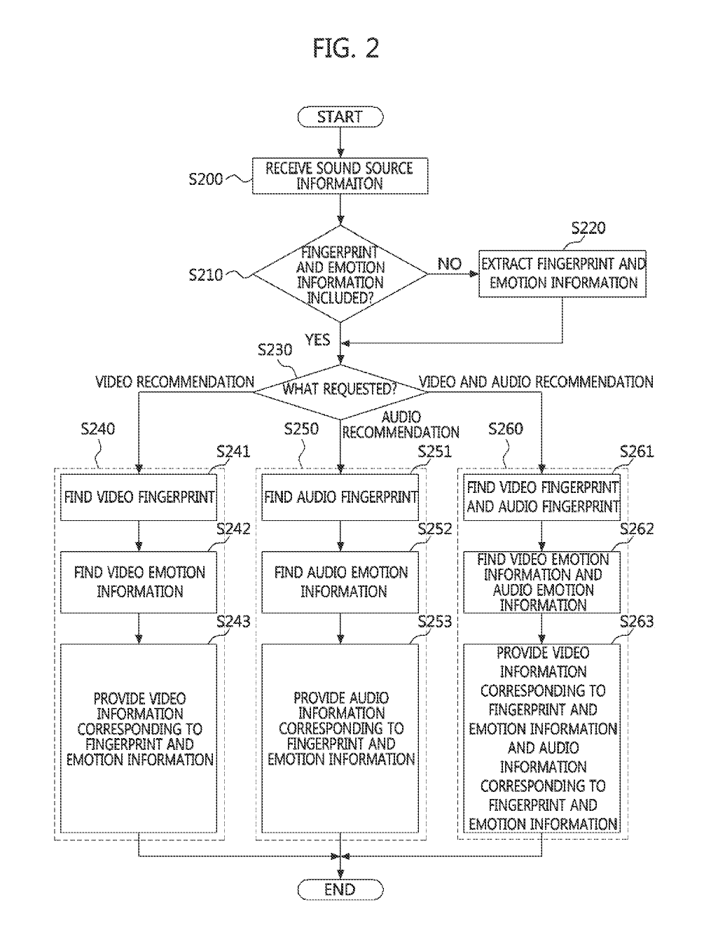

FIG. 2 is a flowchart illustrating a method of recommending content according to an embodiment of the present invention.

Referring to FIG. 2, the content recommendation method may include receiving audio data or fingerprint and emotion information of the audio data from a user (S200), extracting fingerprint and emotion information of the audio data when the audio data is received from the user (S210, S220), finding video information corresponding to fingerprint and emotion information of video data to provide the found video information to the user when the user requests video recommendation (S230, S240), finding audio information corresponding to fingerprint and emotion information of audio data to provide the found audio information to the user when the user requests audio recommendation (S230, S250), and finding video information and audio information corresponding to fingerprints and emotion information of the video data and audio data to provide the found video information and audio information to the user when the user requests video and audio recommendation (S230, S260). Operations S200, S210, S220, S230, S240, S250, and S260 may be performed in the content recommendation server 20.

Operation S200 is an operation of receiving sound source data from a user, where only audio data or fingerprint and emotion information of the audio data may be received as the sound source data.

Operation S210 is an operation of determining whether the sound source information received from the user includes the fingerprint and emotion information of the audio data. If the sound source information includes the fingerprint and emotion information of the audio data, operation S230 is performed. If the sound source information does not include the fingerprint and emotion information of the audio data, operation S220 is performed and then S230 is performed.

Operation S220 is an operation of extracting the fingerprint and the emotion information of the audio data, where one of zero crossing rate (ZCR), energy difference, spectral flatness, mel-frequency cepstral coefficients, and frequency centroids algorithms may be used.

In operation S220, an arousal-valence (AV) coefficient of the audio data may be extracted as emotion information. In this case, operation S220 may include extracting characteristics of the audio data with a regression analysis using mel-frequency cepstral coefficients (MFCC), octave-based spectral contrast (OSC), energy, tempo, etc. and then applying the characteristics to an arousal-valence (AV) model to extract the AV coefficient. Here, the AV model intends to represent a level of human emotion from any content using an arousal level indicating an activation level of the emotion and a valence level indicating a pleasantness level of the emotion.

Operation S230 is an operation of determining which type of recommendation a user requests. If the user requests video recommendation, operation S240 is performed. If the user requests audio recommendation, operation S250 is performed. If the user requests video and audio recommendation, operation S260 is performed.

Operation S240 is an operation of extracting video information corresponding to the fingerprint and emotion information of the audio data to provide the extracted video information to the user if the user requests video recommendation, which may include finding a video fingerprint (S241), finding video emotion information (S242), and providing the video information corresponding to the fingerprint and emotion information to the user (S243).

In operation S241, the video fingerprint corresponding to the fingerprint of the audio data is found in the fingerprint DB 24. In this case, at least one fingerprint may be found in the fingerprint DB 24 according to similarity between the fingerprint of the audio data and the video fingerprint stored in the fingerprint DB 24. That is, the fingerprint represents a frequency characteristic and an amplitude characteristic of the audio data. At least one video fingerprint with a frequency characteristic and an amplitude characteristic similar to the fingerprint of the audio data may be found in the fingerprint DB 24.

In operation S242, the video emotion information corresponding to the emotion information of the audio data may be found in the emotion DB 25. In this case, at least one piece of video emotion information may be found in the emotion DB 25 according to similarity between the emotion information of the audio data and the video emotion information stored in the emotion DB 25. In this case, the AV coefficient may be used as emotion information. At least one AV coefficient which is similar to the AV coefficient of the audio data may be found in the emotion DB 25.

In operations S241 and S242, the similarity may be set according to a user's request. That is, a relatively greater number of video fingerprints or pieces of video emotion information are found when the similarity is set to have a wide range, and a relatively less number of video fingerprints or video emotion information are found when the similarity is set to have a narrow range.

Here, the video fingerprints are stored in the fingerprint DB 24. Moreover, the video information corresponding to the video fingerprints may be stored in the fingerprint DB 24. Accordingly, when at least one video fingerprint is found in the fingerprint DB 24, video information may be found corresponding to the found video fingerprint. Video emotion information (AV coefficient) is stored in the emotion DB 25. Moreover, video information corresponding to the video emotion information may be stored in the emotion DB 25. Accordingly, when at least one video emotion information is found in the emotion DB 25, video information may be found corresponding to the found video emotion information.

In operation S243, common video information may be extracted from video information corresponding to the video fingerprint found in operation S241, and video information corresponding to video emotion information found in operation S242, and then the extracted common video information may be provided to the user.

Operation S250 is an operation of extracting audio information corresponding to the fingerprint and emotion information of the audio data to provide the extracted audio information to the user if the user requests audio recommendation, which may include finding a audio fingerprint (S251), finding audio emotion information (S252), and extracting the audio information corresponding to the fingerprint and emotion information, and then providing the extracted audio information to the user (S253).

In operation S251, the audio fingerprint corresponding to the fingerprint of the audio data may be found in the fingerprint DB 24. In this case, at least one audio fingerprint may be found in the fingerprint DB 24 according to similarity between the fingerprint of the audio data and the audio fingerprint stored in the fingerprint DB 24. That is, the fingerprint represents a frequency characteristic and an amplitude characteristic of the audio data. At least one audio fingerprint with a frequency characteristic and an amplitude characteristic similar to the fingerprint of the audio data may be found in the fingerprint DB 24.

In operation S252, the audio emotion information corresponding to the emotion information of the audio data may be found in the emotion DB 25. In this case, at least one piece of audio emotion information may be found in the emotion DB 25 according to similarity between the emotion information of the audio data and the audio emotion information stored in the emotion DB 25. In this case, the AV coefficient may be used as emotion information. At least one AV coefficient which is similar to the AV coefficient of the audio data may be found in the emotion DB 25.

In operations S251 and S252, the similarity may be set according to a user's request. That is, a relatively greater number of audio fingerprints or pieces of audio emotion information are found when the similarity is set to have a wide range, and a relatively less number of audio fingerprints or audio emotion information are found when the similarity is set to have a narrow range. Here, the audio fingerprints are stored in the fingerprint DB 24. Moreover, the audio information corresponding to the audio fingerprints may be stored in the fingerprint DB 24. Accordingly, when at least one audio fingerprint is found in the fingerprint DB 24, audio information may be found corresponding to the found audio fingerprint. Audio emotion information (AV coefficient) is stored in the emotion DB 25. Moreover, audio information corresponding to the audio emotion information may be stored in the emotion DB 25. Accordingly, when at least one audio emotion information is found in the emotion DB 25, audio information may be found corresponding to the found audio emotion information.

In operation S253, common audio information may be extracted from audio information corresponding to the audio fingerprint found in operation S251, and audio information corresponding to audio emotion information found in operation S252, and then the extracted common audio information may be provided to the user.

Operation S260 is an operation of providing video information and audio information corresponding to the fingerprint and emotion information if the user requests video and audio recommendation, which may include finding a video fingerprint and a audio fingerprint (S261), finding video emotion information and audio emotion information (S262), and extracting the video information and audio information corresponding to the fingerprint and emotion information, and then providing the extracted information to the user (S263). Here, the video fingerprint and audio fingerprint may be found through operations S241 and S251. The video emotion information and audio emotion information may be found through operations S242 and S252. The video information and audio information corresponding to the fingerprint and emotion information may be found through operations S243 and S253.

The content recommendation method according to an embodiment of the present invention has been described in detail above. A video extraction method according to an embodiment of the present invention will be described in detail below.

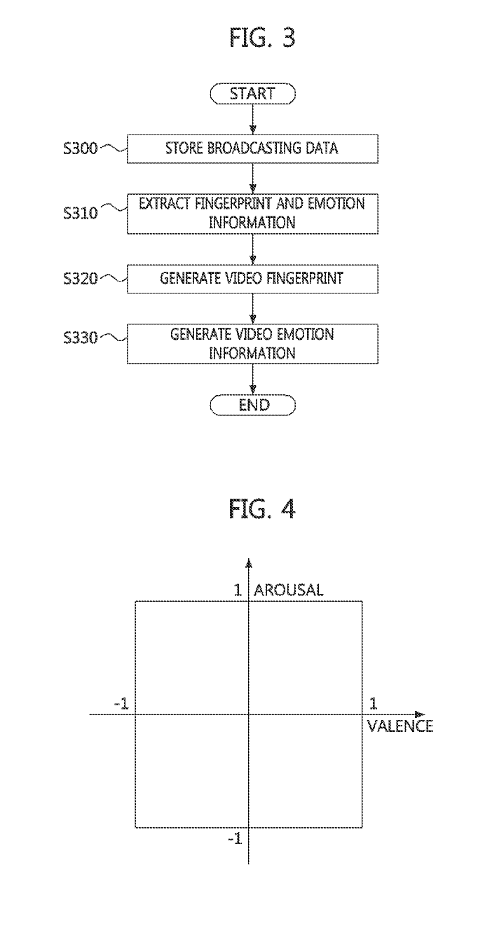

FIG. 3 is a flowchart illustrating a method of extracting video according to an embodiment of the present invention.

Referring to FIG. 3, the video extraction method may include storing broadcasting data (S300), extracting a fingerprint and emotion information (S310), generating a video fingerprint (S320), and generating video emotion information (S330).

In operation S300, real-time broadcasting data is stored. In this case, all or a portion of broadcasting data about one broadcasting program may is stored.

In operation S310, the fingerprint and emotion information are extracted with the all or a portion of broadcasting data stored in operation S300. In this case, the fingerprint and emotion information may be extracted with only audio data of the broadcasting data.

In operation S310, the fingerprint may be extracted with one of zero crossing rate (ZCR), energy difference, spectral flatness, mel-frequency cepstral coefficients (MFCC), and frequency centroids algorithms.

In operation S310, an arousal-valence (AV) coefficient of the broadcasting data may be extracted as emotion information. In this case, the second extraction unit 32 may extract characteristics of the broadcasting data with a regression analysis using mel-frequency cepstral coefficients (MFCC), octave-based spectral contrast (OSC), energy, tempo, etc., and then apply the characteristics to an arousal-valence (AV) model to extract the AV coefficient.

Operation S320 may include adding video information to the audio fingerprint extracted in operation S310 to generate video fingerprint, and then storing the generated video fingerprint to the fingerprint DB 24.

Operation S330 may include adding the video information to the audio emotion information extracted in operation S310 to generate video emotion information, and then storing the generated video emotion information to the emotion DB 25.

According to the present invention, it is possible to recommend music files desired by the user with emotion information in addition to a fingerprint of sound source data, thereby providing more varieties of music information to the user.

Also, it is possible to recommend broadcasting information about music in addition to music information desired by the user, thereby providing varieties of content information to the user.

Also, it is possible to extract the fingerprint and emotion information of real-time broadcasting data to recommend real-time broadcast contents with the extracted fingerprint and emotion information of the broadcasting data.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A content recommendation server comprising:
a first extraction unit extracting a fingerprint and emotion information of audio data;
a search unit finding a video fingerprint or audio fingerprint corresponding to the fingerprint extracted by the first extraction unit in a fingerprint DB, and finding video emotion information or audio emotion information corresponding to the emotion information extracted by the first extraction unit in an emotion DB; and
a provision unit extracting at least one of video information corresponding to the video fingerprint and video emotion information found by the search unit, and audio information corresponding to the audio fingerprint and audio emotion information found by the search unit, and providing at least one of the video information and the audio information to a user.

2. A content recommendation system comprising:
a first extraction unit extracting a fingerprint and emotion information of audio data;
a second extraction unit extracting a fingerprint and emotion information of audio data for video data;
a generation unit adding video metadata to the fingerprint extracted by the second extraction unit to provide the fingerprint which is added the video metadata to a fingerprint DB, and adding the video metadata to the emotion information extracted by the second extraction unit to provide the emotion information which is added the video metadata to an emotion DB;
a search unit finding a video fingerprint or audio fingerprint corresponding to the fingerprint extracted by the first extraction unit in the fingerprint DB, and finding video emotion information or audio emotion information corresponding to the emotion information extracted by the first extraction unit in the emotion DB; and
a provision unit extracting at least one of video information corresponding to the video fingerprint and video emotion information found by the search unit, and audio information and audio information corresponding to the audio fingerprint and audio emotion information found by the search unit.

3. The content recommendation system of claim 2, further comprising a storage unit storing real-time broadcasting data,
wherein the second extraction unit extracts a fingerprint and emotion information of audio data for the broadcasting data stored in the storage unit, and
the generation unit adds broadcasting metadata to the fingerprint extracted by the second extraction unit to generate a video fingerprint, and adds the broadcasting metadata to the emotion information extracted by the second extraction unit to generate video emotion information.

4. The content recommendation system of claim 2, wherein the emotion information is an arousal-valence (AV) coefficient of each data.

5. The content recommendation system of claim 2, wherein the first extraction unit and the second extraction unit extract the fingerprint of the audio data using one of zero crossing rate (ZCR), energy difference, spectral flatness, mel-frequency cepstral coefficients (MFCC), and frequency centroids algorithms.

6. A content recommendation method performed in a content recommendation server, the content recommendation method comprising:
receiving audio data or a fingerprint and emotion information of the audio data;
extracting a fingerprint and emotion information of the received audio data when the audio data is received;
extracting video information corresponding to the fingerprint and emotion information of the audio data to provide the extracted video information to a user if video recommendation is requested; and
extracting audio information corresponding to the fingerprint and emotion information of the audio data to provide the extracted audio information to the user if audio recommendation is requested.

7. The content recommendation method of claim 6, wherein the emotion information is an arousal-valence (AV) coefficient of the audio data.

8. The content recommendation method of claim 6, wherein the extracting of the fingerprint and emotion information of the received audio data is performed using one of zero crossing rate (ZCR), energy difference, spectral flatness, mel-frequency cepstral coefficients (MFCC), and frequency centroids algorithms.

9. The content recommendation method of claim 6, wherein the extracting of video information corresponding to the fingerprint and emotion information of the audio data further comprises:
finding a video fingerprint corresponding to the fingerprint of the audio data;
finding video emotion information corresponding to the emotion information of the audio data; and
extracting video information corresponding to the found video fingerprint and video emotion information to provide the extracted video information to the user.

10. The content recommendation method of claim 6, wherein the extracting of audio information corresponding to the fingerprint and emotion information of the audio data further comprises:
finding an audio fingerprint corresponding to the fingerprint of the audio data;
finding audio emotion information corresponding to the emotion information of the audio data; and
extracting audio information corresponding to the found audio fingerprint and audio emotion information to provide the extracted audio information to the user.
